(19) United States
(12) Patent Application Publication
(10) Pub. No.: US 2010/0089342 A1
(43) Pub. Date: Apr. 15, 2010

(54) CHARGE-AIR COOLING DEVICE, SYSTEM FOR TURBOCHARGING AND/OR CHARGE-AIR COOLING, METHOD FOR CHARGE-AIR COOLING

(75) Inventors: Jurgen Wegner, Eislingen/Fils (DE); Joachim Huster, Berg (DE)

Correspondence Address: BACHMAN & LAPOINTE, P.C., 900 CHAPEL STREET, SUITE 1201, NEW HAVEN, CT, 06510, US

(73) Assignees: BEHR GMBH & CO. KG, Stuttgart (DE); MTU FRIEDRICHSHAFEN GMBH, Friedrichshafen (DE)

(21) Appl. No.: 12/529,091

(22) PCT Filed: Feb. 27, 2008
(86) PCT No.: PCT/EP2008/001526

§ 371 Date: Nov. 20, 2009

(30) Foreign Application Priority Data
Feb. 28, 2007 (DE) 10 2007 010 123.8

(51) Int. Cl. F01P 7/14; F02M 15/00; F02B 33/00

(52) U.S. Cl. 123/41.08; 123/542; 123/563

(57) ABSTRACT

An apparatus for charge air cooling for an internal combustion engine of a motor vehicle, comprising a first heat exchanger for charge air high-pressure cooling, and at least one second heat exchanger for charge air low-pressure cooling, and at least one first connecting element for connecting a first heat exchanger and the at least one second heat exchanger together, at least one coolant supply conduit for supplying at least one heat exchanger with coolant, at least one coolant discharge conduit for the discharge of coolant from at least one of the heat exchangers, wherein the at least one coolant supply conduit and the at least one coolant discharge conduit are arranged substantially completely in the at least one first connecting element.

### BACKGROUND OF THE INVENTION

The present invention concerns an apparatus for charge air cooling for an internal combustion engine of a motor vehicle and a system for charge air cooling and/or turbocharging of an internal combustion engine of a motor vehicle as well as a method of charge air cooling for an internal combustion engine of a motor vehicle.

To improve the efficiency of internal combustion engines the air which is drawn in out of the ambient atmosphere is charged in a single-stage or multi-stage procedure by means of a compressor of a turbocharger. In that case the compressed air increases in temperature and therefore has to be cooled down again after compression. That is effected by means of a heat exchanger for charge air cooling. In that case the charged air can be cooled directly or indirectly. In direct charge air cooling the charged air is cooled directly by the ambient air. In indirect charge air cooling the charge air is cooled by a coolant which in turn is cooled by the ambient air.

In addition it is known, in multi-stage and in particular two-stage charge air charging, for the charge air to be cooled in a multi-stage procedure.

Furthermore after compression in a first compressor stage the charge air can be cooled by means of an intercooler before the charge air is compressed again to a higher pressure level in a further compressor stage. Then, renewed cooling of the charge air is effected in a further heat exchanger for charge air cooling, before the charge air is fed to the internal combustion engine of a motor vehicle.

DE 3504038 discloses a cooling installation for a water-cooled internal combustion engine provided with a turbocharger, wherein an intercooler is known in the induction system of the machine, for cooling the charge air delivered by the turbocharger.

EP 1505274 discloses a charge air cooler having a cooling insert through which a cooling medium can flow and which is arranged in the charge air-carrying connecting passage.

DE 10351845 discloses parallel heat exchanger modules which are connected to an exhaust gas intake housing and form a high-temperature exhaust gas heat exchanger and parallel heat exchanger modules which are connected to an exhaust gas outlet housing and form a low-temperature exhaust gas heat exchanger.

The housings of the heat exchanger modules are provided with flanges for mounting purposes at the ends. The high-temperature exhaust gas heat exchanger is rigidly fixed to the exhaust gas inlet housing by means of a fastening ring structure. At another end the high-temperature exhaust gas heat exchanger is mounted to a flange in a mounting plate so that forced stresses are avoided.

EP 0874142 discloses an apparatus for integrated guidance of liquid and gaseous media of an internal combustion engine with a housing held to the internal combustion engine in adjacent relationship with a cylinder head and a fastening flange for a forced-induction device for combustion air.

The heat exchangers for the charge air or exhaust gas cooling are in that case respectively connected to a plurality of conduits or tubes which feed coolant to the heat exchangers and discharge coolant from the heat exchangers. Those conduits must generally be fixed to a plurality of different holding elements in the engine bay. The coolant for cooling the charge air coolers or the other heat exchangers such as for example exhaust gas coolers can in that case be branched out of the coolant circuit for cooling the internal combustion engine. In that case a large number of interfaces is required, which for example are in the form of pipe branching elements.

The object of the present invention is to improve an apparatus of the kind set forth in the opening part of this specification. In particular the invention seeks to provide that the complication and expenditure for coolant supply conduits for feeding or discharging coolant to or from the heat exchangers for the charge air and/or exhaust gas cooling is reduced. At the same time the invention seeks to provide that the number of interfaces and the required branching elements in the coolant-carrying conduits is reduced. In addition the invention seeks to provide in particular that the assembly time required to connect the coolant supply conduits to the heat exchangers is reduced. Furthermore the invention aims to provide that assembly itself is simplified.

### SUMMARY OF THE INVENTION

There is proposed an apparatus for charge air cooling for an internal combustion engine of a motor vehicle, comprising a first heat exchanger for charge air high-pressure cooling. The apparatus further has at least one second heat exchanger for charge air low-pressure cooling. In addition there is provided at least one first connecting element for connecting the first heat exchanger and the at least one second heat exchanger together. The apparatus has at least one coolant supply conduit for supplying at least one heat exchanger with coolant and at least one coolant discharge conduit for the discharge of coolant from at least one of the heat exchangers. The at least one coolant supply conduit and the at least one coolant discharge conduit are arranged substantially completely in the at least one first connecting element.

The expression the one ‘first heat exchanger for charge air high-pressure cooling’ is used to denote in particular a charge air cooler in which charge air is cooled, which was compressed to a high-pressure level at least by means of two compression stages of a turbocharger. The first heat exchanger however can also be an exhaust gas cooler and/or an oil cooler and/or an evaporator or condenser of an air conditioning installation.

The expression the ‘second heat exchanger for charge air low-pressure cooling’ is used to denote in particular a charge air cooler for cooling charge air which was drawn in from the ambient atmosphere and compressed to a charge air low-pressure level by means of a first compressor stage of a turbocharger.

In that respect the term ‘charge air low pressure’ is used to mean that the charge air is at a higher pressure than the ambient air, but the charge air low pressure is lower than the charge air high pressure.

In that respect the charge air low pressure is produced by a first compressor stage of a turbocharger. The charge air high pressure is produced by an at least second compressor stage of a turbocharger.

The at least one first connecting element, in particular a connecting plate, serves in that case to connect the first heat exchanger and the at least second heat exchanger together.

Coolant is supplied by way of the at least one coolant supply conduit at least to a heat exchanger, in particular the charge air high-pressure heat exchanger and/or the charge air low-pressure heat exchanger.

The at least one coolant discharge conduit serves for the discharge of coolant from at least one heat exchanger, in particular the charge air high-pressure heat exchanger and/or the charge air low-pressure heat exchanger.

The at least one coolant supply conduit and the at least one coolant discharge conduit are arranged substantially completely, in particular completely, in the at least one first connecting element, in particular in the at least one first connecting plate or are integrated thereinto.

In accordance with an advantageous development of the invention the first coolant supply conduit branches at least into a first feed flow passage portion for supplying the first heat exchanger, in particular the charge air high-pressure heat exchanger, with coolant and a second feed flow passage portion for supplying the second heat exchanger, in particular the charge air low-pressure heat exchanger. The first feed flow passage portion and the at least one second feed flow passage portion are arranged substantially completely, in particular completely, in the at least one first connecting element, in particular the at least one first connecting plate.

In accordance with an advantageous development of the invention the first feed flow passage portion branches into a third feed flow passage portion and into a fourth feed flow passage portion for supplying the first heat exchanger, in particular the high-pressure charge air cooler, wherein the third feed flow passage portion and the fourth feed flow passage portion are arranged substantially completely in the first connecting element, in particular the connecting plate. In that way it is particularly advantageously possible to save on structural space. In addition assembly of the apparatus can be particularly simplified.

In accordance with an advantageous development of the invention the first connecting element, in particular the at least one connecting plate, has a first discharge flow passage portion for the discharge of coolant from the first heat exchanger, in particular from the high-pressure charge air cooler. In addition the first connecting element has at least one second discharge flow passage portion for the discharge of coolant from the second heat exchanger, in particular from the low-pressure charge air cooler. The first discharge flow passage portion and the at least one second discharge flow passage portion open into the coolant discharge conduit. In that way the number of coolant connecting conduits can be particularly advantageously reduced and assembly can be simplified.

In accordance with an advantageous development of the invention the first connecting element, in particular the connecting plate, has a first flange surface for flange mounting of the first heat exchanger, in particular the charge air high-pressure heat exchanger, and/or a second flange surface for flange mounting of the at least one second heat exchanger, in particular the charge air low-pressure heat exchanger. In that way the at least one first heat exchanger and the at least one second heat exchanger can be particularly advantageously flange mounted to the first connecting element. In addition the at least one first heat exchanger and the second at least one second heat exchanger can be particularly advantageously connected together, wherein the coolant feed and/or discharge conduits can be particularly advantageously integrated into the at least one connecting element.

In accordance with an advantageous development of the invention the first flange surface and the second flange surface are arranged in substantially mutually opposite relationship and/or mutually parallel relationship. In that way the first heat exchanger and the second heat exchanger can be connected together in a particularly structural space-saving fashion.

In an advantageous development of the invention the first flange surface and/or the second flange surface can be at an angle of between 0° and 90° relative to each other.

In an advantageous development of the invention there are provided a second connecting element and a third heat exchanger for exhaust gas cooling for exhaust gas of the internal combustion engine, in particular an exhaust gas heat exchanger.

The second connecting element, in particular the second connecting plate, serves to connect the third heat exchanger, in particular the exhaust gas heat exchanger, to the first connecting element, in particular the first connecting plate. In that way the first heat exchanger, the second heat exchanger and the third heat exchanger can be particularly advantageously connected together. In addition coolant supply and discharge conduits for the first heat exchanger and/or the second heat exchanger and/or the third heat exchanger can be particularly advantageously integrated into the first connecting element, in particular the first connecting plate, and/or into the second connecting element, in particular the second connecting plate.

In accordance with an advantageous development of the invention it can be further be provided in accordance with the invention that the first connecting element, in particular the connecting plate, and the second connecting element, in particular the second connecting plate, are arranged substantially at a right angle to each other and/or are of an integral configuration.

In accordance with the invention a system for charge air cooling and/or turbocharging of an internal combustion engine of a motor vehicle with an apparatus as set forth in one of claims 1 through 8 is known. The system has a first compressor stage of a turbocharger for compressing charge air, and a second compressor stage of a turbocharger for further compressing the charge air, wherein the first heat exchanger, in particular the high-pressure charge air cooler, is arranged downstream of the second compressor stage, and the second heat exchanger, in particular the low-pressure charge air cooler, is arranged downstream of the first compressor stage and/or upstream of the second compressor stage. The term ‘turbocharger’ is used to mean that a compressor stage, in particular a compressor, is coupled to a turbine by means in particular of a shaft. In that case the turbine is driven by the exhaust gas from an internal combustion engine and drives the compressor by way of the coupling. The compressor, in particular the compressor stage, compresses charge air from a lower pressure level to a higher pressure level.

In accordance with an advantageous development of the invention the second heat exchanger is integrated into at least one compressor stage.

In that respect the expression ‘integrated into at least one compressor stage’ is used to mean in particular that the second heat exchanger and in particular the low-pressure charge air heat exchanger is arranged in the compressor housing of the first compressor stage and/or in the housing of the second compressor stage. Structural space can be saved in a particularly advantageous fashion in that way.

In accordance with the invention moreover there is provided a method of charge air cooling for an internal combustion engine of a motor vehicle, which has the following method steps:

Coolant flows into a coolant supply conduit of a first connecting element, in particular the first connecting plate, of an apparatus, in particular as set forth in one of claims 1 through 8.

The coolant flowing in the coolant supply conduit is divided into a first coolant flow portion and a second coolant flow portion.

The coolant of the first coolant flow portion flows substantially directly out of the first connecting element, in particular the first connecting plate, into a first heat exchanger for high-pressure charge air cooling.

The coolant of the second coolant flow portion flows substantially directly out of the first connecting element, in particular the first connecting plate, into a second heat exchanger for low-pressure charge air cooling.

In an advantageous development of the invention the coolant of the second coolant flow portion flows through the second heat exchanger, in particular the low-pressure charge air heat exchanger. In that case the coolant cools charge air which was pre-compressed in a first compressor stage of a first turbocharger. The coolant of the first coolant flow portion flows through the first heat exchanger and in so doing cools charge air which was further compressed in a second compressor stage of a second turbocharger.

An advantageous development of the invention further provides that after flowing through the first heat exchanger the coolant of the first coolant flow portion flows substantially directly from the first heat exchanger, in particular the charge air high-pressure cooler, into the first connecting element, in particular the first connecting plate, and/or after flowing through the second heat exchanger, in particular the low-pressure charge air cooler, it flows directly from the second heat exchanger into the first connecting element, in particular the first connecting plate.

Further advantageous configurations of the inventions are to be found in the appendant claims and the drawing. The subjects of the appendant claims relate both to the apparatus according to the invention for charge air cooling for an internal combustion engine of a motor vehicle and also to the system according to the invention for charge air cooling and/or turbocharging of an internal combustion engine of a motor vehicle as well as the method of charge air cooling for an internal combustion engine of a motor vehicle.

### BRIEF DESCRIPTION OF THE DRAWINGS

Embodiments by way of example of the invention are illustrated in the drawing and described in greater detail hereinafter, without that being intended to involve a limitation of the invention. In the drawing:

FIG. 1 shows a front view of the first connecting plate,

FIG. 2 shows a rear view of the first connecting plate,

FIG. 3 shows a sectional view A-A of the first connecting plate,

FIG. 4 shows an isometric view of the first connecting plate and the second connecting plate,

FIG. 5 shows an isometric view of the apparatus for charge air cooling and for exhaust gas cooling, and

FIG. 6 shows a front view of a system for charge air cooling and/or for turbocharging.

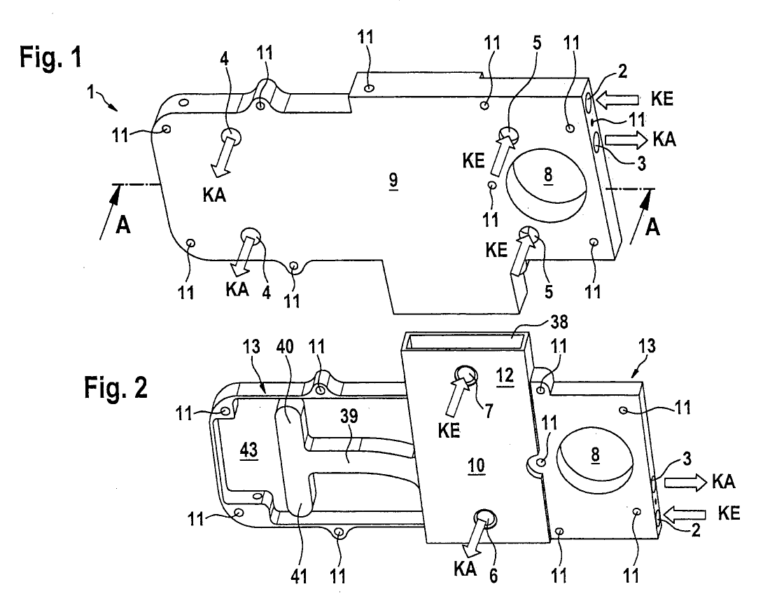

FIG. 1 shows a front view of the first connecting plate 1.

### DETAILED DESCRIPTION

The first connecting plate 1 is of a substantially rectangular configuration. The connecting plate has a first flange surface 9 and a second flange surface 10. At least one parallelepipedic projection is formed out of the connecting plate 1, from a side surface (not identified in greater detail) of the plate. On the side opposite the side with the parallelepipedic projection the connecting plate has a step.

In addition tongue-shaped projections are formed from the side surfaces (not identified in greater detail) of the connecting plate, which projections are introduced for example into fastening openings 11, in particular fastening bores. The connecting plate can have rounded corners and/or angular corners. Fastening openings 11 are provided on the edge surfaces (not identified in greater detail) which can be provided substantially perpendicularly to the first flange surface 9 and/or the second flange surface 10. In addition a side surface (not identified in greater detail) which in particular is perpendicular to the first flange surface 9 and/or the second flange surface 10 has at least one first intake opening 2 for the intake of coolant into the first connecting plate 1. Likewise provided at that side surface is a first outlet opening 3 for the outlet of coolant from the first connecting plate 1. In the illustrated embodiment the first intake opening 2 and the first outlet opening 3 are arranged at the same side surface of the connecting plate 1.

In another embodiment the first intake opening 2 and the first outlet opening 3 can be arranged at different side surfaces of the first connecting plate 1. Likewise the first connecting plate 1 can have more than one intake opening and/or more than one outlet opening 3.

In the illustrated embodiment the first flange surface 9 has at least one and in particular two second outlet openings for the outlet of coolant. Furthermore the first connecting plate 1 has at least one second intake opening 5, in particular at least two second intake openings 5.

Coolant passes into the first connecting plate by way of the intake opening 5. In the illustrated embodiment the two second outlet openings 4 and/or the two second intake openings 5 are respectively disposed on a straight line extending substantially parallel to the side surface (not identified) in which the first intake opening 2 and the first outlet opening 3 are provided.

The two second outlet openings 4 and the two second intake openings 5 form the corners of a rectangle in the illustrated embodiment.

In another embodiment which is not illustrated the second outlet openings 4 and the second intake openings 5 are provided at another location on the first flange surface 9. The second intake openings 5 and/or the at least two second outlet openings 4 are of a substantially circular configuration. In another embodiment the said openings are elliptical or are of any other shape. The connecting plate 1 has a through opening 8 which is substantially cylindrical. The through opening 8 extends substantially perpendicularly to the first flange surface 9 and/or the second flange surface 10. The through opening 8 is cylindrical but it can also be of another non-circular cross-sectional area or can be in the shape of a truncated cone element.

The through opening 8 is arranged at least region-wise between the two second intake openings 5. The through opening 8 has a center point (not identified) which is at the same spacing from the two center points of the second intake openings 5.

In the present embodiment the through opening 8 has a center point (not identified) which is at substantially the same spacing from the two center points of the second outlet openings 4. The two second outlet openings 4, the two second intake openings 5 and the four fastening openings 11 of the first flange surface 9 are substantially so arranged that they are substantially axially symmetrical with respect to a straight line (not shown) extending through the center point of the through opening 8 and through the center point of a fastening opening 11.

The first intake opening 2 and the first outlet opening 3 are substantially circular.

The first connecting plate 1 is made from a material such as for example metal, in particular aluminum, steel or high-quality steel or a plastic or ceramic or a composite fiber material.

The contour of the first connecting plate 1 is produced by means of a master-pattern production process such as for example casting or by means of a material-removal and/or cutting production process such as for example milling, boring, laser cutting and so forth.

The first intake opening 2, the first outlet opening 3, the second outlet openings 4 and/or the second intake openings 5 as well as the fastening openings 11 or the through opening 8 are produced in the first connecting plate 1 by means of a material-removal production process such as for example boring and/or abrasion and/or laser cutting. The first flange surface 9 serves for flange mounting of the first heat exchanger. The first heat exchanger is in particular a charge air cooler such as for example a charge air high-pressure cooler. In another embodiment (not shown) the first heat exchanger to be flange mounted is an exhaust gas cooler and/or a coolant cooler and/or an oil cooler.

FIG. 2 shows a rear view of the first connecting plate 1. The same features are denoted by the same references as in FIG. 1.

The first connecting plate 1 is formed substantially from a first substantially cuboidal subelement 12 and a second substantially cuboidal subelement 13. The two substantially cuboidal subelements 12 and 13 are so arranged relative to each other that at least one longer side of the first cuboidal subelement is arranged substantially perpendicularly to a longer side of the second cuboidal subelement 13. The first cuboidal subelement 12 and the second cuboidal subelement 13 are of a one-piece configuration and form the first connecting plate 1. The second cuboidal subelement 13 has the second flange surface 10 for flange mounting a second heat exchanger. The second heat exchanger is a charge air low-pressure cooler, in particular an intercooler or an exhaust gas cooler or an oil cooler or a coolant cooler.

The second cuboidal subelement 13 has a first cavity 38 which is substantially also cuboidal. The second flange surface 10 has at least one third intake opening 7 and at least one third outlet opening 6. The third outlet opening 6 and/or the third intake opening 7 communicate with the first cavity 38. The third outlet opening 6 and/or the third intake opening are of a circular cross-sectional area. They can however also be of a cylindrical cross-sectional area or a cross-sectional area of a rectangular or other angular shape. The third outlet opening 6 and the third intake opening 7 are arranged substantially symmetrically on the second flange surface 10. The third outlet opening 6 and the third intake opening 7 are arranged substantially on a straight line forming the surface bisector of the second flange surface 10. In the illustrated embodiment the third outlet opening 6 and the third intake opening 7 are in the form of step bores. The third outlet opening 6 and the third intake opening 7 are provided in the second cuboidal subelement 13 by means of a material-removing production process such as for example boring and/or countersinking.

The first cuboidal subelement 12 is of a greater thickness than the second cuboidal subelement 13. Thus the first cuboidal subelement 12 projects with a thick region (not identified in greater detail) beyond the second cuboidal subelement 13. The second cuboidal subelement 13 also has a second cavity 43. The second cavity 43 has a base surface (not identified in greater detail) of rectangular elements, partially with rounded corners. A rectangular side surface (not identified in greater detail) extending substantially peripherally surrounds the second surface 43 and is substantially perpendicular to the base surface (not identified). Arranged in the second cavity 43 is a first limb element 39, the limb element 39 being substantially of a rectangular, in particular parallelepipedic cross-sectional area. The first limb element 39 branches into a first limb subelement 40 and a second limb subelement 41. The first limb subelement 40 and/or the second limb subelement 41 are provided at least region-wise with rounded-off corners. The first limb subelement 40 and the second limb subelement 41 are of a substantially one-piece configuration and are substantially in the form of a slot groove filled with material.

The first limb subelement 40 and/or the second limb subelement 41 are substantially perpendicular to the first limb element 39. Thus the first limb element 39, the first limb subelement 40 and the second limb subelement 41 substantially form a T-shape. The height (not identified) of the first limb element 39 and/or the first limb subelement 40 and/or the second limb subelement 41 substantially corresponds to the height of the rectangular area surrounding the second cavity 43. The second cavity 43 is substantially surrounded by an element in band form. Formed out of the element in band form are two tongue-shaped subelements, in each of which there is respectively provided at least one fastening opening 11. The at least one fastening opening and in particular the fastening openings 11 serve for fastening the first connecting plate to at least one first heat exchanger and/or to an at least second heat exchanger. The first cuboidal subelement 12, in particular the second flange surface 10, has a semicylindrical aperture in the region of a fastening opening 11.

The third outlet opening 6 serves for the outlet of coolant KA. The third intake opening 7 serves for the intake of coolant KE.

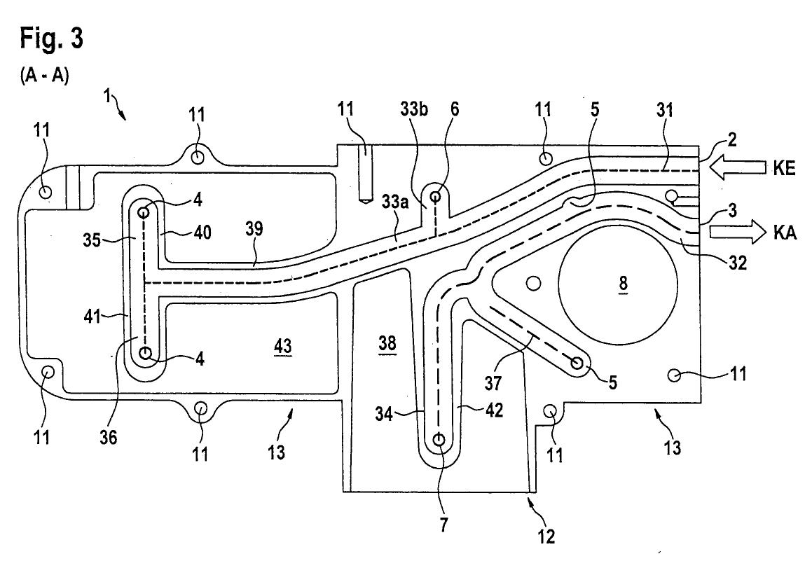

FIG. 3 shows a sectional view A-A of the first connecting plate 1. The same features are denoted by the same references as in the preceding Figures.

The first connecting plate 1 has a first coolant supply conduit 31 which is substantially of a semi-shaped cross-sectional area. The first coolant supply conduit 31 can have coolant flowing therethrough by way of the first intake opening 2, by way of the coolant intake KE. The coolant supply conduit 31 branches into a first feed flow passage portion 33a for a flow of coolant to the first heat exchanger, in particular the charge air cooler such as for example the charge air high-pressure cooler, and a second feed flow passage portion 33b for the flow of coolant to the second heat exchanger, in particular the low-pressure charge air cooler such as for example the intercooler. The first feed flow passage portion 33a branches into a third feed flow passage portion 35 and into a fourth feed flow passage portion 36. The first feed flow passage portion 33a is provided at least portion-wise in the first limb element 39. The third feed flow passage portion 35 is provided in the first limb subelement 40. The fourth feed flow passage portion 36 is provided in the second limb subelement 41. The coolant supply conduit 31, the first feed flow passage portion 33a, the second feed flow passage portion 33b, the third feed flow passage portion 35 and the fourth feed flow passage portion 36 are substantially of a circular cross-sectional area. In another embodiment the aforementioned conduits or passages are of a substantially angular, parallelepipedic, rectangular or elliptical shape or are of a cross-sectional area of the aforementioned shapes.

The first connecting plate 1 also has a first discharge flow passage portion 37 for the discharge of coolant from the first heat exchanger, in particular a high-pressure charge air cooler, and at least one second discharge flow passage portion 34 for the discharge of coolant from the second heat exchanger. The first discharge flow passage portion 37 and the second discharge flow passage portion 34 open in particular into the coolant discharge conduit 32. The second discharge flow passage portion is at least portion-wise arranged in a second limb element 42 of the first cuboidal subelement 12 of the connecting plate 1. The first discharge flow passage portion 37, the second discharge flow passage portion 34 and the coolant discharge conduit 32 are substantially of a circular cross-section. In another embodiment the aforementioned conduits or passages are of a rectangular, parallelepipedic or elliptical cross-sectional shape or are of a cross-sectional area with a combination of the aforementioned shapes.

The first coolant supply conduit 31 and/or the first coolant discharge conduit 32 and/or the first feed flow passage portion 33a and/or the second feed flow passage portion 33b and/or the third feed flow passage portion 35 and/or the fourth feed flow passage portion 36 and/or the second discharge flow passage 34 and/or the first discharge flow passage portion 37 are provided in the first connecting plate by means of a master-pattern production process such as for example casting, in particular lost-core casting.

The second feed flow passage portion 33b and/or the second discharge flow passage portion 34 and/or the third feed flow passage portion 35 and/or the fourth feed flow passage portion 36 are arranged substantially parallel to each other.

The third feed flow passage portion 35 and the fourth feed flow passage portion 36 are arranged substantially on a straight line. The second feed flow passage portion 33b and the second discharge flow passage portion 34 are arranged substantially on a straight line relative to each other. The coolant supply conduit 31 and the coolant discharge conduit 32 extend at least portion-wise parallel to each other. The second discharge flow passage portion 34 and the first discharge flow passage portion 37 are substantially at an angle (not identified) which is of values between 0° and 90°, in particular between 10° and 70°, in particular between 20° and 45°. The coolant discharge conduit 32 follows at least region-wise a peripheral portion of the through opening 8. The second limb element 42 is provided in the first cavity 38. The second limb element 42 is arranged substantially on the side bisector of the cross-sectional area of the first cuboidal subelement 12.

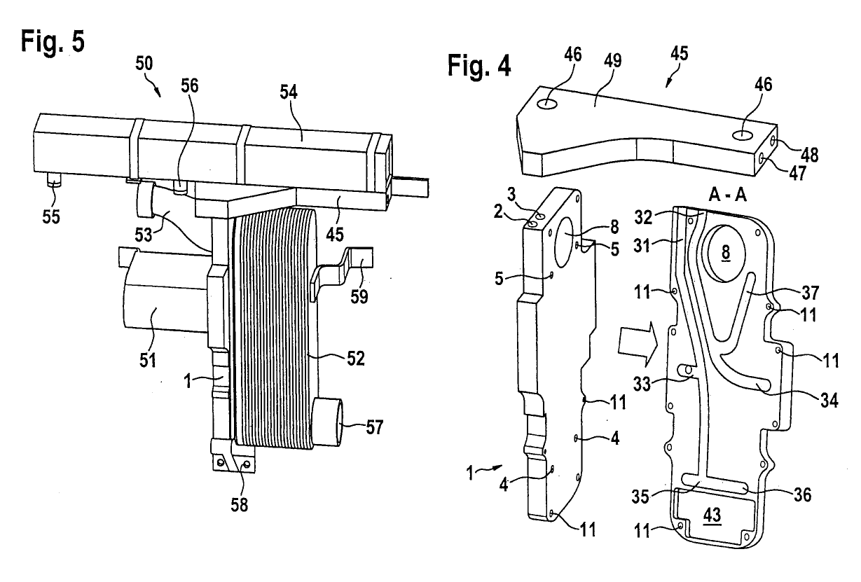

FIG. 4 shows an isometric view of the first connecting plate 1 and a second connecting plate 45. The same features are denoted by the same references as in the preceding Figures.

The second fastening subelement 45 is in the form of a second fastening subelement 45, in particular a fastening plate 45. The fastening plate 45 is substantially in the form of a plate from which for example at least one triangular plate element is formed. In another embodiment (not shown) at least one triangular and/or tongue-shaped subelement can be formed from the fastening plate 45. The fastening subelement 45 is made from metal such as for example aluminum, steel or high-quality steel and/or from plastic or for example from ceramic or a composite fiber material.

The fastening plate 45 has two fastening bores 46 for example for fastening a third heat exchanger such as for example an exhaust gas cooler and/or a further charge air cooler and/or an oil cooler. In addition the fastening plate 45 has a fourth intake opening 47 for the intake of coolant into the fastening plate 45. Furthermore the fastening plate 45 has at least one fourth outlet opening 48 for the outlet of coolant from the fastening plate, in particular the second fastening plate 45. Furthermore the first coolant supply conduit 31 and/or the first coolant discharge conduit 32 are arranged or provided respectively at least in portion-wise fashion in the second fastening plate 45. The first fastening plate 1 and the second fastening plate 45 are for example sealingly connected together so that the conduit portion of the coolant supply conduit 31 provided in the second fastening element can communicate with the conduit portion of the first coolant supply conduit 31 arranged in the first connecting plate 1 without this involving leaks. In addition the conduit portion of the first coolant discharge conduit 32, that is arranged in the second fastening plate 45, can communicate in particular by way of the first outlet opening 3 with the conduit portion of the first coolant discharge conduit 32, that is arranged in the first fastening plate 1. In a development of the invention the first fastening plate 1 and the second fastening plate 45 are of a one-part configuration or are joined together by a connection involving intimate joining of the materials involved and/or in force-locking relationship and/or in positively locking relationship, in particular being tightly connected together. The conduit regions, arranged in the second fastening plate 45, of the coolant supply conduit 31 and the coolant discharge conduit 32 are provided in the second fastening plate for example by means of a master-pattern production process such as casting, in particular lost-core casting. The first connecting plate 1 and the second connecting plate 45 are arranged substantially perpendicularly to each other. In particular the second connecting or fastening plate 45 has a flange surface 49 for flange mounting at least one third heat exchanger such as for example an exhaust gas cooler and/or a further charge air cooler and/or an oil cooler. The second fastening or connecting plate 45 and the first connecting plate 1 are arranged substantially relative to each other in such a way that the surface normal of the third flange surface 49 is arranged substantially at a right angle to the surface normal of the first flange surface 9 and/or the second flange surface 10. In particular the first connecting plate 1 and the second connecting plate 45 are so arranged relative to each other that the first intake opening 2 of the first connecting plate is arranged substantially concentrically or coaxially with a corresponding opening of the second connecting plate 45. Likewise the first outlet opening 3 of the first connecting plate is arranged concentrically or substantially coaxially with the corresponding opening of the second connecting plate 45.

FIG. 5 shows an isometric view of the apparatus for charge air cooling and for exhaust gas cooling. The same features are denoted by the same references as in the preceding Figures.

The cooling module 50 has a first heat exchanger 52, in particular a charge air cooler such as for example a high-pressure charge air cooler. In addition the cooling module 50 has a second heat exchanger 51, in particular a charge air cooler such as for example a low-pressure charge air cooler. In addition the cooling module 50 has at least one third heat exchanger 54, in particular an exhaust gas heat exchanger. In another embodiment the first heat exchanger 52, the second heat exchanger 51 and the at least one third heat exchanger 54 can be a charge air cooler and/or an exhaust gas cooler and/or an oil cooler and/or a coolant cooler for engine cooling.

The high-pressure charge air cooler 52 has a base plate (not identified in greater detail) on which plates (not identified in greater detail) are stacked in such a way that flow passages for charge air and/or coolant are provided between adjacent plates. The plates stacked in mutually superposed relationship are substantially of such a configuration that a substantially rectangular region is adjoined by respective semicircular regions. By means of a base plate (not identified) the high-pressure charge air cooler 52 is fixed with fastening elements such as screws, nuts and so forth to the first fastening element or the first fastening plate, or is flange mounted to the first flange surface 9. The charge air intake connection 53 of the high-pressure charge air cooler 52 is flange mounted or connected directly to the first fastening plate. In another embodiment the charge air intake connection 53 passes through the through opening 8 and is flange mounted to the base plate (not identified in greater detail) of the high-pressure charge air cooler 52 or is joined to that base plate, in particular being joined by intimate connection of the materials involved and/or in positively locking relationship. In another embodiment the charge air intake connection 53 is connected to the first connecting element 1. By way of the charge air intake connection, uncooled charge air flows into the high-pressure charge air cooler 52. The charge air cooled down in the high-pressure charge air cooler 52 flows out of same by means of the charge air outlet connection 57. The low-pressure charge air cooler 51 is arranged in substantially opposite relationship, in particular on the opposite side of the first connecting plate 1, and is flange mounted to the second flange surface 10. The low-pressure charge air cooler 51 is joined at least region-wise to the first connecting plate in positively locking relationship and/or in force-locking relationship and/or by a connection involving intimate joining of the materials involved. In particular the low-pressure charge air cooler 51 is connected to the first connecting element 1 by means of connecting elements such as screws, nuts and so forth.

In another embodiment the high-pressure charge air cooler 52 is in the form of a heat transfer device or heat exchanger with tube nests. The tubes are in particular in the form of flat tubes. They are accommodated in at least one tube plate, in particular in two tube plates. Turbulence-generating elements such as winglets, corrugated ribs or turbulence-inducing inserts can be introduced and/or impressed into the tubes.

The low-pressure charge air cooler 51 has tubes, in particular flat tubes. In another embodiment the low-pressure charge air cooler 51 is formed similarly to the high-pressure charge air cooler 52 from plates which are stacked in mutually superposed relationship and which form flow passages for coolant, in particular cooling water, and charge air passages.

In another embodiment the low-pressure charge air cooler 51 is in the form of a heat transfer device or heat exchanger with tube nests. The tubes are in particular in the form of flat tubes. They are received in at least one tube plate, in particular in two tube plates. Turbulence-generating elements such as winglets or turbulence-inducing inserts can be introduced and/or impressed into the tubes.

The exhaust gas heat exchanger 54 is fixed by way of fastening elements to the second connecting or fastening element 45. The exhaust gas heat exchanger 54 has a coolant intake connection 55 for the intake of coolant into the exhaust gas heat exchanger and a coolant outlet 56 for the outlet of coolant from the exhaust gas heat exchanger. The exhaust gas heat exchanger 54 has a casing in which in particular rectangular tubes are disposed. In another embodiment the exhaust gas heat exchanger 54 is formed similarly to the high-pressure charge air cooler 52 from plates stacked in mutually superposed relationship. Those plates stacked in mutually superposed relationship form flow passages for exhaust gas to be cooled and for coolant such as for example water-bearing cooling liquid. The cooling module 50 is fixed to an engine (not shown), in particular an internal combustion engine for a motor vehicle, by means of a first engine fastening element 58 and/or a second engine fastening element 59.

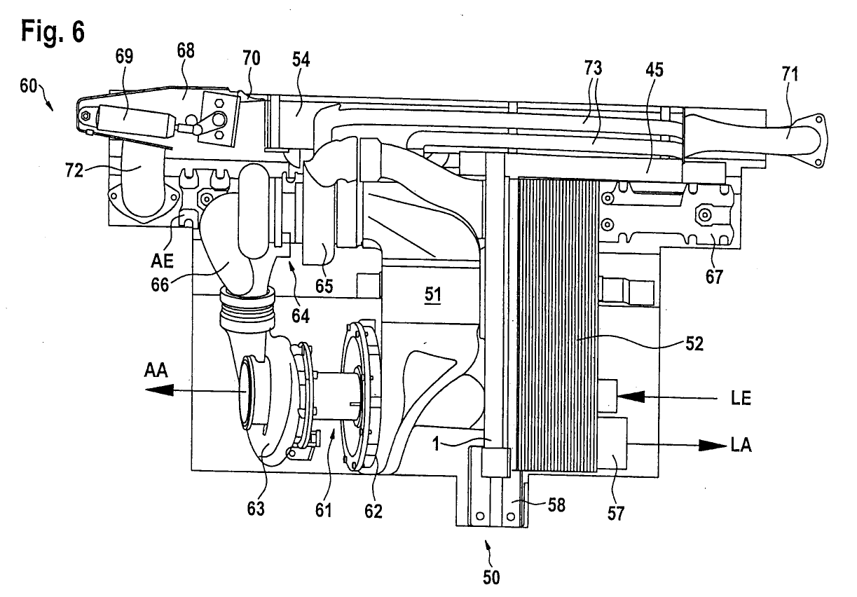

FIG. 6 shows a front view of a system 60 for charge air cooling and/or for turbocharging. The same features are denoted by the same references as in the previous Figures. The charge air/exhaust gas cooling and turbocharging system 60 has a cooling module 50 as described with reference to FIG. 5.

In addition the system 60 has a first turbocharger stage 61 and a second turbocharger stage 64.

Furthermore the system 60 has a bypass flap 68 or an exhaust gas valve 68 or a combivalve 68 which controls the exhaust gas recycle rate through the exhaust gas cooler 54 and/or the passage of exhaust gas through a bypass passage.

Charge air flows through the charge air inlet LE into the first compressor 62 of the first turbocharger stage 61 and is compressed therein from the ambient pressure to a low pressure. The low pressure is higher than the ambient pressure. The temperature of the forced-induction air is cooled down in the low-pressure charge air cooler 51. The coolant required for that purpose flows through the first fastening element 1 and/or the second connecting element 45. After flowing through the low-pressure charge air cooler 51 the charge air is compressed to a high-pressure level in a second turbocharger stage 64 by means of a second compressor 65. A higher pressure obtains in the high-pressure level than in the low-pressure level. Upon compression of the charge air in the second compressor 65 the temperature of the charge air increases. The charge air then flows through the charge air intake connection into the charge air high-pressure cooler 52, flows therethrough and in so doing is cooled down by coolant which flows in the first connecting element and is supplied by way thereof to and/or discharged from the charge air high-pressure cooler 52. The charge air which is cooled down in the high-pressure charge air cooler 52 leaves same through the charge air outlet connection 57 and is fed to an internal combustion engine (not shown).

Fuel and supplied cooled charge air undergo combustion in the internal combustion engine (not shown), to give exhaust gas. If required a part of the exhaust gas can be recycled to the engine. For that purpose however the exhaust gas is previously cooled. Exhaust gas flows by way of an exhaust gas intake connection 72 into the exhaust gas intake diffuser 70 and further through the exhaust gas cooler 54. The exhaust gas cooler 54 can have a bypass conduit. Exhaust gas is recycled to the internal combustion engine in an uncooled state through the bypass conduit. The supply of the recycled exhaust gas to the bypass passage and/or to the exhaust gas cooler 54 is controlled or regulated by means of the combivalve 68 and/or the bypass flap 68 and/or by means of the exhaust gas recycle valve. That is effected by means of an actuator 69. The recycled cooled and/or uncooled exhaust gas is fed to the internal combustion engine through the exhaust gas outlet connection 71. Coolant is passed into the exhaust gas cooler or passed out of the exhaust gas cooler 54 by way of exhaust gas coolant conduits 73.

The non-recycled part of the exhaust gas flows through the first turbine 66 of the second turbocharger stage and then through the second turbine 63 of the first turbocharger stage. In that way the first turbine 66 drives the second compressor 65. Likewise the second turbine 63 drives the first compressor 62. The first compressor 62 and/or the second compressor 65 and/or the first turbine 66 and/or the second turbine 63 are each substantially in particular in the shape of a scroll housing. The second heat exchanger for low-pressure charge air cooling is arranged in or integrated into a housing (not identified) of the first compressor 62 and/or into a housing (not identified) of the second compressor 65. The housing (not identified) of the first compressor 62 and the housing (not identified) of the second compressor 65 can be of a one-part structure. The cooling module 50 is fixed for example to an internal combustion engine (not shown) by means of a third engine fastening element 67. In the illustrated embodiment in the first turbocharger stage and/or the second turbocharger stage the turbines are radial turbines and the compressors are radial compressors.

In another embodiment, in the first turbocharger stage and/or the second turbocharger stage the turbines are axial turbines and the compressors are axial compressors.

The features of the various embodiments an be combined together as desired. The invention can also be used for areas other than those shown. Exhaust gas passes into the first turbine 66 by way of the exhaust gas intake AE. After flowing through the second turbine 63 the exhaust gas flows out of the second turbine 63 from the exhaust gas outlet AA.

1. Apparatus for charge air cooling for an internal combustion engine of a motor vehicle, comprising
a first heat exchanger for charge air high-pressure cooling,
at least one second heat exchanger for charge air low-pressure cooling,
and at least one connecting element for connecting the first heat exchanger and the at least one second heat exchanger together,
at least one coolant supply conduit for supplying at least one heat exchanger with coolant,
at least one coolant discharge conduit for the discharge of coolant from at least one of the heat exchangers,
wherein
the at least one coolant supply conduit and the at least one coolant discharge conduit are arranged substantially completely in the at least one first connecting element.

2. Apparatus as set forth in claim 1 wherein the first coolant supply conduit branches at least into a first feed flow passage portion for supplying the first heat exchanger with coolant and a second feed flow passage portion for supplying the second heat exchanger, wherein the first feed flow passage portion and the at least one second feed flow passage portion are arranged substantially completely in the at least first connecting element.

3. Apparatus as set forth in claim 2 wherein the first feed flow passage portion branches into a third feed flow passage portion and into a fourth feed flow passage portion for supplying the first heat exchanger, wherein the third feed flow passage portion and the fourth feed flow passage portion are arranged substantially completely in the first connecting element.

4. Apparatus as set forth in claim 1 wherein the first connecting element has a first discharge flow passage portion for the discharge of coolant from the first heat exchanger and at least one second discharge flow passage portion for the discharge of coolant from the second heat exchanger, wherein the first discharge flow passage portion and the at least one second discharge flow passage portion open into the coolant discharge conduit.

5. Apparatus as set forth in claim 1 wherein the first connecting element has a first flange surface for flange mounting of the first heat exchanger and a second flange surface for flange mounting of the at least second heat exchanger.

6. Apparatus as set forth in claim 5 wherein the first flange surface and the second flange surface are arranged in substantially mutually opposite relationship and/or mutually parallel relationship.

7. Apparatus as set forth in claim 1 wherein there are provided at least one second connecting element and a third heat exchanger for exhaust gas cooling for exhaust gas from the internal combustion engine, wherein the second connecting element serves for connecting the third heat exchanger to the first connecting element.

8. Apparatus as set forth in claim 7 wherein the first connecting element and the second connecting element are arranged substantially at a right angle to each other and/or are of an integral configuration.

9. A system for charge air cooling and/or turbocharging of an internal combustion engine of a motor vehicle with an apparatus as set forth in claim 1 comprising
a first compressor stage of a turbocharger for compressing charge air, and
a second compressor stage of a turbocharger for further compressing the charge air, wherein the first heat exchanger is arranged downstream of the second compressor stage, characterised in that the second heat exchanger is arranged downstream of the first compressor stage and/or upstream of the second compressor stage.

10. A system as set forth in claim 9 wherein the second heat exchanger is integrated into at least one compressor stage.

11. A method of charge air cooling for an internal combustion engine of a motor vehicle,
comprising the following steps:
(a) providing an apparatus comprising a first heat exchanger for charge air high-pressure cooling, at least one second heat exchanger for charge air low-pressure cooling, and at least one connecting element for connecting the first heat exchanger and the at least one second heat exchanger together, at least one coolant supply conduit for supplying at least one heat exchanger with coolant, at least one coolant discharge conduit for the discharge of coolant from at least one of the heat exchangers, wherein the at least one coolant supply conduit and the at least one coolant discharge conduit are arranged substantially completely in the at least one first connecting element;
(b) causing a coolant to flow into the coolant supply conduit of the connecting element of an apparatus;
(c) dividing the coolant flowing in the coolant supply conduit into a first coolant flow portion and a second coolant flow portion;
(d) flowing the coolant of the first coolant flow portion substantially directly from the first connecting element into the first heat exchanger for high-pressure charge air cooling; and
(e) flowing the coolant of the second coolant flow portion substantially directly from the first connecting element into a second heat exchanger for low-pressure charge air cooling.

12. A method as set forth in claim 11 including flowing the coolant of the second coolant flow portion through the second heat exchanger to cool charge air which was pre-compressed in a first compressor stage of a first turbocharger and/or flowing the coolant of the first coolant flow portion through the first heat exchanger to cool charge air which was further compressed in a second compressor stage of a second turbocharger.

13. A method as set forth in claim 11 including after flowing through the first heat exchanger, flowing the coolant of the first coolant flow portion substantially directly from the first heat exchanger into the first connecting element and/or after flowing through the second heat exchanger, flowing the coolant of the second coolant flow portion substantially directly from the second heat exchanger into the first connecting element.
